(19) United States
(12) Patent Application Publication
(10) Pub. No.: US 2010/0192736 A1
(43) Pub. Date: Aug. 5, 2010

(54) SCREWDRIVER

(76) Inventors: Wade Burch, Wauwatosa, WI (US); Michael S. Steele, Waukesha, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/701,370

(22) Filed: Feb. 5, 2010

Related U.S. Application Data
(60) Provisional application No. 61/150,153, filed on Feb. 5, 2009.

(51) Int. Cl. B25B 23/00; B25B 15/00

(52) U.S. Cl. 81/438; 81/436

(57) ABSTRACT

A driver tool configured to engage and drive the head of a threaded fastener includes a shank defining a longitudinal axis. The shank has a mating end and a driver end. A driver head is coupled to the shank adjacent the driver end. The driver head includes a first driving portion having a substantially square cross section normal to the axis and a geometric center along the axis. The first driving portion includes four walls and a corner at an intersection of adjacent walls such that the first driving portion includes a first corner, a second corner, a third corner opposite the first corner, and a fourth corner opposite the second corner. The driver head further includes a second driving portion including a first flange extending radially outward from the first driving portion and a second flange extending radially outward from the first driving portion. The second flange is opposite the first flange, and each of the flanges includes an end wall having a midpoint. A plane passing through the first corner and the third corner of the first driving portion passes through the midpoints of the end walls of the second driving portion.

### CROSS-REFERENCE TO RELATED PATENT APPLICATION

This application claims priority to U.S. Provisional Patent Application No. 61/150,153, filed Feb. 5, 2009, the entire contents of which is incorporated by reference herein.

### BACKGROUND OF THE INVENTION

The present invention relates to a hand tool, and in particular a drive device for combination head fasteners.

Combination or “combo” head fasteners were developed to be driven by either a conventional flat-head type driver or a Phillips-head type driver. Some combination fastener head designs can also receive a Robertson type square driver. All three types of drivers have disadvantages when used with a combination head fastener. Flat-head drivers require a user to manually hold the driver bit substantially centered in the fastener head slot and aligned with the axis of the fastener shank, and care must be taken to maintain alignment between the fastener and driver. Phillips-head drivers are self-centering within the fastener head, but have a tendency to “cam-out” of the fastener head in high torque applications. Robertson drivers have a tendency to strip combination type fastener heads at relatively low torques.

### SUMMARY OF THE INVENTION

In one embodiment, the invention provides a driver tool configured to engage and drive the head of a threaded fastener. The driver tool includes a shank defining a longitudinal axis. The shank has a mating end and a driver end. A driver head is coupled to the shank adjacent the driver end. The driver head includes a first driving portion having a substantially square cross section normal to the axis and a geometric center along the axis. The first driving portion includes four walls and a corner at an intersection of adjacent walls such that the first driving portion includes a first corner, a second corner, a third corner opposite the first corner, and a fourth corner opposite the second corner. The driver head further includes a second driving portion including a first flange extending radially outward from the first driving portion and a second flange extending radially outward from the first driving portion. The second flange is opposite the first flange, and each of the flanges includes an end wall having a midpoint. A plane passing through the first corner and the third corner of the first driving portion passes through the midpoints of the end walls of the second driving portion.

In another embodiment, the invention provides a bit for driving threaded fasteners. The bit includes a shank having a first end, a second end, a longitudinal axis and a first cross-sectional profile. A mating portion is coupled to the first end of the shank for mating the bit with a driving apparatus. A driving portion is coupled to the second end of the shank. The driving portion includes a recess driving portion and a slot driving portion. The recess driving portion has four walls and four corners forming a substantially square cross section normal to the longitudinal axis. The slot driving portion has a pair of flanges extending radially from opposing corners of the recess driving portion.

In yet another embodiment, the invention provides a screwdriver configured to rotatably drive a threaded fastener head. The screwdriver includes a shaft having a central axis, a first end, and second end. A handle is coupled to the first end of the shaft and a driving head is coupled to the second end of the shaft. The driving head comprises a first driving portion including four walls and four corners defining a square cross section relative to the central axis. The first driving portion is configured to engage a central recess of the fastener head. The driving head further includes a second driving portion including a pair of flanges extending radially outward from opposing corners of the first driving portion. Each flange has a pair of opposing walls and an end wall extending therebetween. The second driving portion is configured to engage an elongated slot of the fastener head. The second driving portion extends radially outward from opposing corners of the first driving portion.

Other aspects of the invention will become apparent by consideration of the detailed description and accompanying drawings.

### BRIEF DESCRIPTION OF THE DRAWINGS

FIG. 1 is a perspective view of a screwdriver according to one embodiment of the invention.

FIG. 2 is a partial front perspective view of a driving head of the screwdriver of FIG. 1.

FIG. 3 is a front view of the screwdriver of FIG. 1.

FIG. 4 is a top view of a combination-type screw head.

FIG. 5 is a perspective view of a screwdriver according to another embodiment of the invention.

FIG. 6 is a partial front perspective view of a driving head of the screwdriver of FIG. 5.

FIG. 7 is a partial front perspective view of a screwdriver according to another embodiment of the invention.

FIG. 8 is a front perspective view of a combination bit according to one embodiment of the invention.

FIG. 9 is a rear perspective view of the combination bit of FIG. 8.

FIG. 10 is a front view of the combination bit of FIG. 8.

FIG. 11 is a perspective view of a combination bit according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

### DETAILED DESCRIPTION

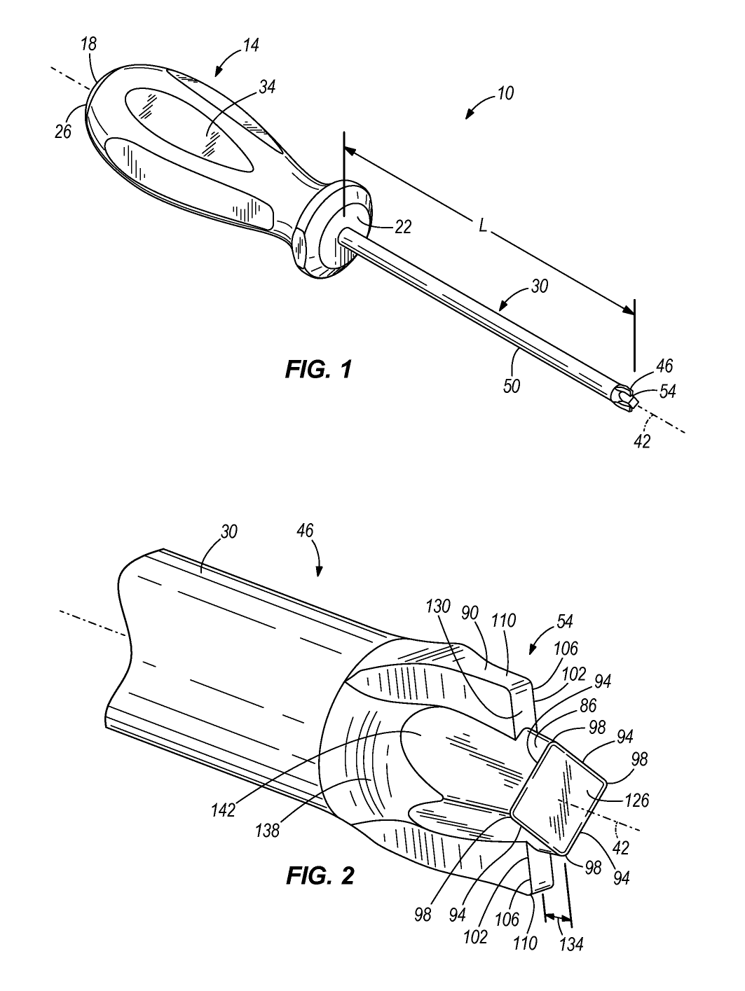

FIGS. 1-3 illustrate a screwdriver 10 according to one embodiment of the invention. The screwdriver 10 includes a handle 14 having a first end 18 and a second end 22. A rounded pommel 26 is formed at the first end 18 of the handle 14, and screwdriver shaft 30 projects outwardly from the second end 22 of the handle 14. The handle 14 also includes gripping surfaces 34 for a user such that the user may grip the handle 14 for the tightening and loosening of a fastener, such as a screw head 38 (FIG. 4). The handle 14 is coupled to the shaft 30, and the user transmits torque from the handle 14 to the screw head 38 via the shaft 30. In the illustrated embodiment, the handle 14 is fixedly coupled to the shaft 30. In further embodiments, the handle 14 may be molded over a shaft extension, unitarily formed with the shaft, or otherwise fixedly or detachably coupled to the shaft.

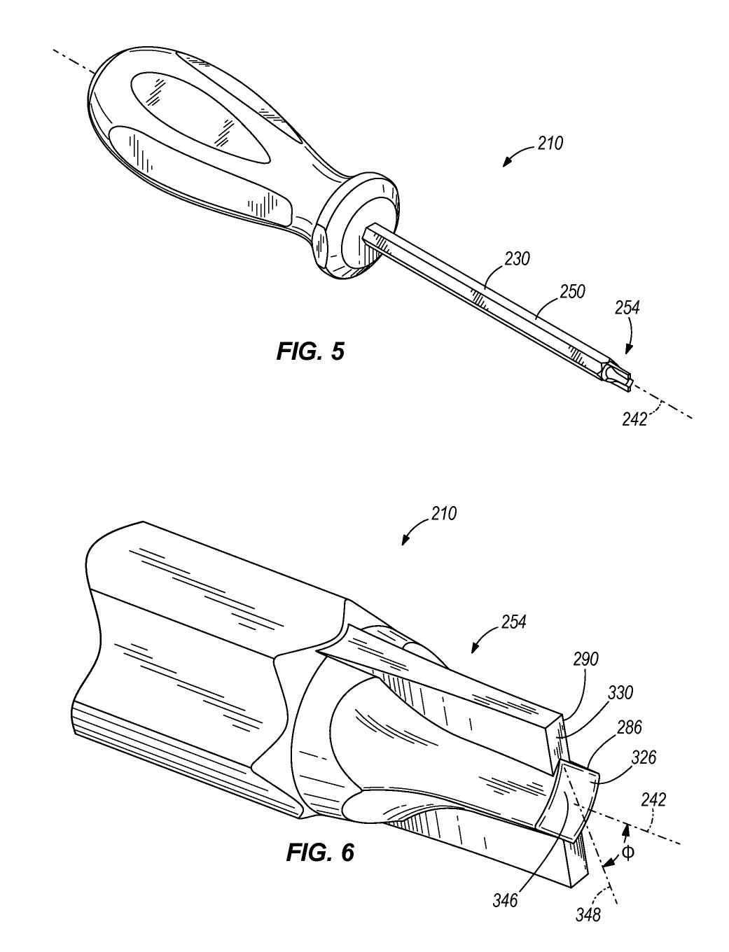

The shaft 30 extends from the handle 14 along a central axis 42 and includes a driver end 46. A shaft length L, defined as a distance between the second end 22 of the handle 14 and the driver end 46, may be of various lengths, depending on the particular application of the screwdriver. In the illustrated embodiment, the shaft length L is between approximately 90 mm and approximately 110 mm. Referring to FIG. 1, the shaft 30 has a rounded cross-sectional profile 50, although in other embodiments, the shaft may have a hexagonal (FIG. 5), square, triangular, or other cross-sectional profile.

Referring to FIGS. 1-3, the driver end 46 of the shaft 13 includes a driving head 54, which in the illustrated embodiment is integrally formed with the shaft 30 as a single piece. The driving head 54 may be integrally cast, forged or machined into the shaft 30. Alternatively, the driving head 54 may be welded to the shaft 30, or a female portion of the driving head 54 may be pressed or adhesively bonded over a male portion of the shaft 30. Further, the driving head 54 may undergo various heat treatment, surface hardening, plating or coating processes to optimize the hardness, toughness, wear resistance, or corrosion resistance of the tool.

The driving head 54 has a shape and configuration for mating with a combination or combo screw head 38, an example of which is illustrated in FIG. 4. The combination screw head 38 can be driven by a conventional flat head, cross-head (i.e., Phillips), or square (i.e., Robertson) screwdriver. The head 38 has an outer diameter 58 and a cruciform-shaped drive socket 62. The drive socket 62 is defined by a full-diameter slot 66 and a partial diameter elongated recess 70. The recess 70 is substantially perpendicular to the slot 66. The slot 66 is configured to receive a traditional flat-head type driver. The recess 70, in combination with a central portion 74 of the slot 66, is configured to receive a tapered, cruciform cross section of a Phillips-type driver. A square, central recess 78, at the intersection of the slot 66 and the recess 70, is surrounded by four diagonal walls 82. The central recess 78 is configured to receive a Robertson-type driver. In most screws, the central recess 78 has a greater depth, measured from a top surface of the screw head, than the slot 66.

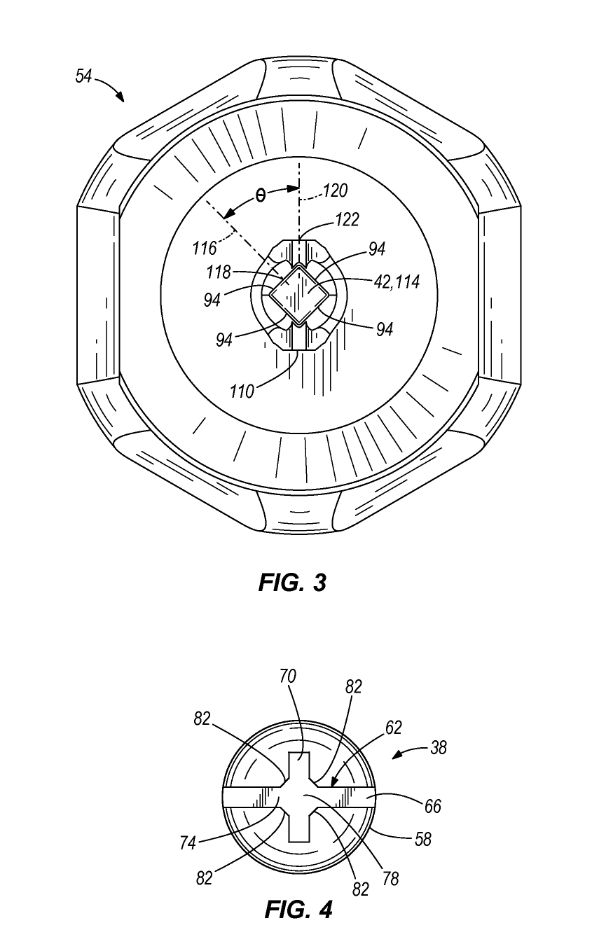

Referring to FIGS. 2 and 3, the driver head 54 includes a first driving portion 86 and a second driving portion 90. The first driving portion 86 has a substantially square-shaped cross section, which is sized and shaped to mate with the central recess 78 of the combination screw head 38 (FIG. 4). The first driving portion 86 includes four driving faces 94 and a corner 98 at the intersection of adjacent driving faces 94. The first driving portion 86 is configured to engage with and drive the walls 82 of the screw head central recess 78.

The second driving portion 90 has a substantially rectangular-shaped cross section, which is sized and shaped to mate with the slot 66 of the combination screw head 38. The second driving portion 90 is formed by flanges 102 that extend from opposite corners 98 of the first driving portion 86. Each of the flanges 102 is formed by a pair of walls 106 extending outwardly from the first driving portion 86. In the illustrated embodiment, the walls 106 are substantially parallel to each other. An end portion of each flange 102 includes an end wall 110. In the illustrated embodiment, the first driving portion 86 and the second driving portion 90 share a common geometric center 114 along the central axis 42 of the shaft 30.

An angular orientation ⊖ between the first driving portion 86 and second driving portion 90 is defined by an angle between a first plane 116, extending between the center 114 and a midpoint 118 of one of the driving faces 94 of the first driving portion 86, and a second plane 120, extending between the center 114 and a midpoint 122 of the nearest end wall 110 of the second driving portion 90. In the illustrated embodiment, the angular orientation ⊖ of the first driving portion 86 is approximately 45 degrees. In further embodiments, the angular orientation ⊖ may require a 45 degree shift, depending on screw head and the orientation of the screw slot 66 relative to the central recess 78, such that the midpoint 118 of the driving face 94 is aligned with the midpoint 122 of the nearest end wall 110.

The first driving portion 86 includes a distal end face 126 and the second driving portion 90 includes a distal end face 130. The end face 130 of the second driving portion 90 has an axial offset 134 from the end face 126 of the first driving portion 86. In the illustrated embodiment, the offset 134 corresponds to the difference in depth between the screw head slot 66 and the central recess 78. The axial offset 134 allows for a greater depth of engagement between the first driving portion 86 and the central recess 78, thereby allowing for higher torque transmission prior to stripping either the screw head or driver.

Comparing the driving head 54 of FIGS. 2-3 with the recess configuration of the exemplary screw head 38 of FIG. 4, the driving head 54 does not directly engage the recess 70 of the head 38. The driving faces 94 of the first driving portion 86 engage the walls 82 of the central recess 78, which allows the driving head 54 to provide a tighter fit with combination head screws than a conventional slotted screwdriver or Phillips screwdriver. Unlike Phillips or other cross-head type drivers, the driving head 54 has a reduced tendency to cam-out of the screw head when under high-torque.

A transition region 138 extends between the shaft 30 and the driving head 54, and the transition region 138 includes fillets 142. In the illustrated embodiment, four fillets 142 are provided, each of the fillets 142 corresponding to one of the driving faces 94 of the first driving portion 86. The fillets 142 increase the strength of the tool by minimizing torsional and/or bending stress concentrations in the transition region 138. The transition region 138 is axially offset from the end faces 126, 130 of the driving head 54; therefore, the fillets 142 of the transition region 138 do not affect tool-to-fastener engagement. In further embodiments, other configurations and profiles are possible for the fillets 142.

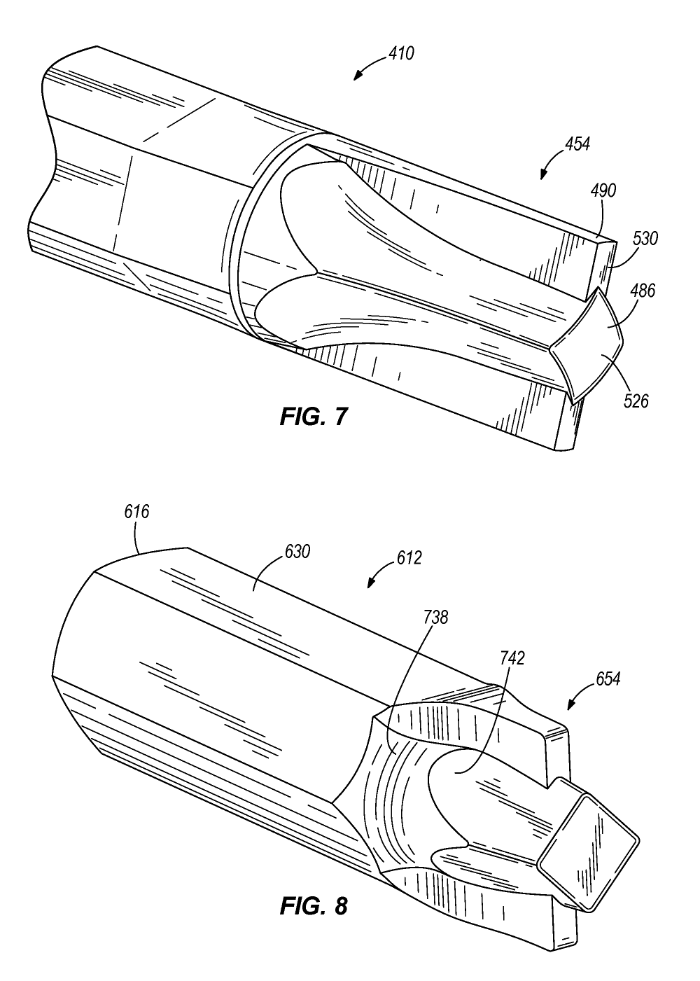

FIGS. 5 and 6 illustrate a screwdriver 210 according to another embodiment of the invention. The screwdriver 210 is similar to the screwdriver 10 illustrated in FIGS. 1-3. Accordingly, features of the screwdriver 210 that are similar to the features of screwdriver 10 have been given similar reference numbers, plus 200. Also, only differences between the screwdriver 10 of FIGS. 1-3 and the screwdriver 210 of FIGS. 5-6 will be discussed in detail below and it should be understood that the features and alternative constructions of the screwdriver 10 discussed above could also be applied to the screwdriver 210.

Referring to FIG. 5, a shaft 230 of the screwdriver 210 has a hexagonal cross-sectional profile 250. Referring to FIG. 6, a driving head 254 of the screwdriver 210 is sized and shaped to engage a #1 size combination screw head (not shown). The driving head 254 includes a first driving portion 286 and a second driving portion 290. A distal end face 326 of the first driving portion 286 and a distal end face 330 of the second driving portion 290 are substantially flush, which allows for better tool-to-slot engagement on fasteners with a shallow central recess. The end face 326 of the first driving portion 286 has a conical profile 346 centered about a central axis 242. An angle Φ is defined between the axis 242 and a line 348 tangent to the conical end face 326. In the illustrated embodiment, the conical angle Φ is approximately 70 degrees. In other embodiments, the conical angle may be greater or less than 70 degrees. The conical profile 346 allows a user to more easily align the driver head 40 with a screw head.

FIG. 7 partially illustrates a screwdriver 410 according to another embodiment of the invention. The screwdriver 410 is similar to the screwdriver 210 illustrated in FIGS. 5-6. Accordingly, features of the screwdriver 410 that are similar to the features of screwdriver 210 have been given similar reference numbers, plus 400. Also, only differences between the screwdriver 210 of FIGS. 5-6 and the screwdriver 410 of FIG. 7 will be discussed in detail below and it should be understood that the features and alternative constructions of the screwdriver 210 discussed above could also be applied to the screwdriver 410.

The screwdriver 410 includes a driving head 454 having a first driving portion 486 and a second driving portion 490. In the illustrated embodiment, a distal end face 526 of the first driving portion 486 and a distal end face 530 of the second driving portion 490 are substantially flush. The driving head 454 is sized and shaped to engage a #2 size combination screw head (not shown).

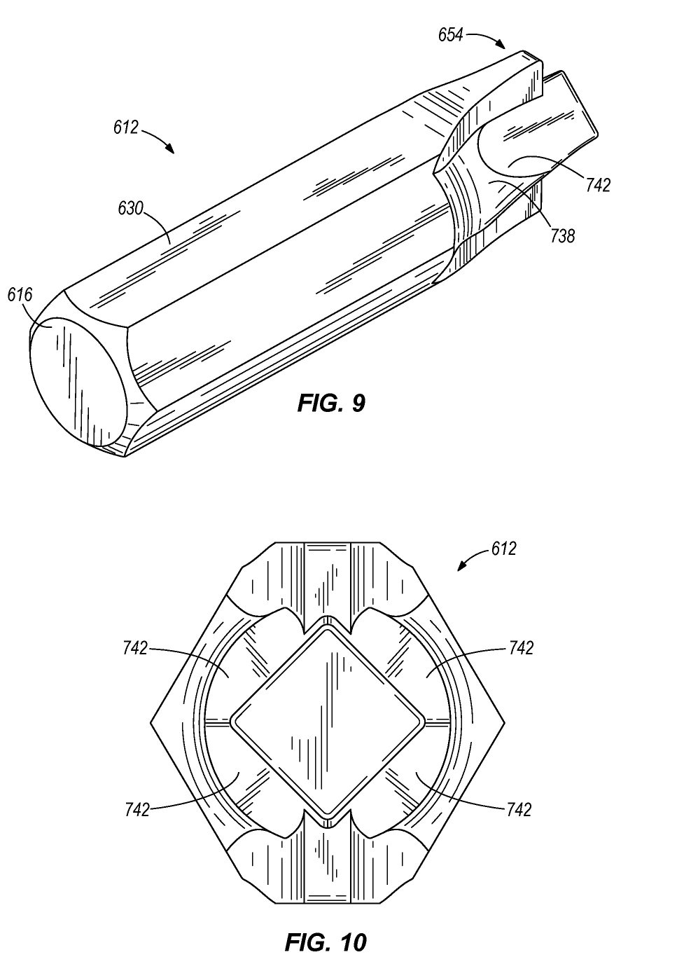

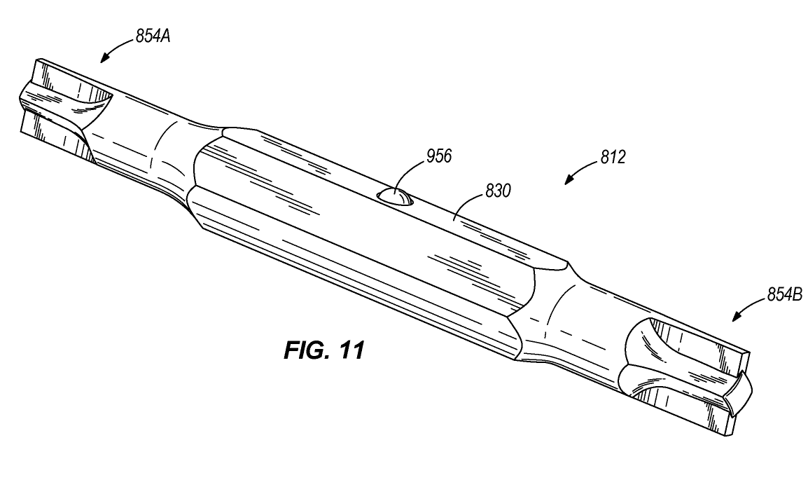

FIGS. 8-10 illustrate a combination bit 612 according to one embodiment of the invention. The combination bit 612 is for use with a screwdriver (not shown) having a handle and a shaft, whereby the bit 612 is removably coupled to the shaft of the screwdriver such that various bits may be interchangeably used with the screwdriver. The bit 612 includes a driving head portion 654 and a shank portion 630 that terminates at a mating end 616. A transition region 738 between the shank portion 630 and the driving head portion 654 is defined by a plurality of fillets 742.

The driving head portion 654 of the combination bit 612 illustrated in FIGS. 8-10 is similar to the driving head 54 of the screwdriver 10 illustrated in FIGS. 1-3. Accordingly, features of the driving head portion 654 that are similar to the features of the driving head 54 have been given similar reference numbers, plus 600. Also, only differences between the driving head 54 of FIGS. 1-3 and the driving head portion 654 of FIGS. 8-10 are discussed in detail above and it should be understood that the features and alternative constructions of the driving head 54 discussed above could also be applied to the driving head portion 654.

The shank portion 630 and mating end 616 have a hexagonal profile sized for use with an interchangeable-bit screwdriver body (not shown). The illustrated combination bit 612 is sized and shaped to mate with a standard 5/16″ driver body. The shank portion 630 may also be used with three-jaw chucks, such as those used in drills and powered screwdriver tools. In the illustrated embodiment, the bit 612 is formed from a magnetic ferrous-alloy so that it may be magnetically retained in a driver body using magnetic retention. In further embodiments, the bit may utilize a spring and ball detent to retain the bit within a driver body, such as is described below with respect to FIG. 11.

FIG. 11 illustrates a double ended combination bit 812 according to one embodiment of the invention. The combination bit 812 is for use with a screwdriver (not shown) having a handle and a shaft, whereby the bit 812 is removably coupled to the shaft of the screwdriver such that various bits may be interchangeably used with the screwdriver. The bit 812 includes a first driving head portion 854A, a second driving head portion 854B, and a shank portion 830 that connects the two driving head portions 854A and 854B. In the illustrated embodiment, the driving head portions 854A, 854B are integrally formed at opposite ends of the detachable bit 812.

The driving head portion 854A of the combination bit 812 illustrated in FIG. 11 is similar to the driving head 254 of the screwdriver 210 illustrated in FIGS. 5-6. The driving head portion 854A is sized and shaped to engage a #1 combination head screw. The driving head portion 854B of the combination bit 812 illustrated in FIG. 11 is similar to the driving head 454 of the screwdriver 410 illustrated in FIG. 7. The driving head portion 854B is sized and shaped to engage a #2 combination head screw. Accordingly, features of the driving head portions 854A, 854B that are similar to the features of the driving heads 254, 454 have been given similar reference numbers, plus 800.

The first driving head 854A and the second driving head 854B share a common longitudinal axis 842. The illustrated combination bit 812 is sized and configured to mate with a standard 5/16″ driver body, though other embodiments may be appropriately sized for other uses. The shank may be of various lengths depending on the end-use. A spring and ball detent arrangement 956 is located at or near a midpoint of the shank portion 830. The detent arrangement 956 is configured to engage a corresponding recess of a tool receptacle.

Thus, the invention provides, among other things, a tool for driving combination-head threaded fasteners. Various features and advantages of the invention are set forth in the following claims.

What is claimed is:

1. A driver tool configured to engage and drive the head of a threaded fastener, the driver tool comprising:
a shank defining a longitudinal axis, the shank having a mating end and a driver end; and
a driver head coupled to the shank adjacent the driver end, the driver head comprising,
a first driving portion having a substantially square cross section normal to the axis and a geometric center along the axis, the first driving portion including four walls and a corner at an intersection of adjacent walls such that the first driving portion includes a first corner, a second corner, a third corner opposite the first corner, and a fourth corner opposite the second corner, and
a second driving portion including a first flange extending radially outward from the first driving portion and a second flange extending radially outward from the first driving portion, the second flange opposite the first flange, and each of the flanges including an end wall having a midpoint,
wherein a plane passing through the first corner and the third corner of the first driving portion passes through the midpoints of the end walls of the second driving portion.

2. The driver tool of claim 1, wherein the first driving portion and second driving portion are unitarily formed.

3. The driver tool of claim 1, wherein each of the flanges includes a pair of substantially parallel walls that are connected by the respective end wall.

4. The driver tool of claim 1, wherein the first driving portion is configured engage a central recess portion of a fastener head and the second driving portion is configured to engage a slotted portion of the fastener head.

5. The driver tool of claim 1, wherein a distal end face of the first driving portion is substantially flush with a distal end face of the second driving portion.

6. The driver tool of claim 1, wherein a distal end face of the second driving portion is axially set-back from a distal end face of the first driving portion.

7. The driver tool of claim 1, wherein a distal end face of the first driving portion has a tapered conical profile.

8. A bit for driving threaded fasteners, the bit comprising:
a shank having a first end, a second end, a longitudinal axis and a first cross-sectional profile;
a mating portion coupled to the first end of the shank, the mating portion for mating the bit with a driving apparatus; and
a driving portion coupled to the second end of the shank, the driving portion including a recess driving portion and a slot driving portion, the recess driving portion having four walls and four corners forming a substantially square cross section normal to the longitudinal axis, and the slot driving portion having a pair of flanges extending radially from opposing corners of the recess driving portion.

9. The bit of claim 8, further comprising a tapered transition region between a cross-sectional profile of the driving portion and the cross-sectional profile of the shank.

10. The bit of claim 9, wherein the tapered transition region is further defined by a plurality fillets extending from the first driving portion.

11. The bit of claim 8, wherein the first driving portion and the second driving portion have a common geometric center along the longitudinal axis of the shank.

12. The bit of claim 8, wherein a distal end face of the first driving portion is substantially flush with a distal end face of the second driving portion.

13. The bit of claim 8, wherein a distal end face of the second driving portion is axially set-back from a distal end face of the first driving portion.

14. A screwdriver configured to rotatably drive a threaded fastener head, the screwdriver comprising:
a shaft having a central axis, a first end, and second end;
a handle coupled to the first end of the shaft; and
a driving head coupled to the second end of the shaft, the driving head comprising,
a first driving portion including four walls and four corners defining a square cross section relative to the central axis, the first driving portion configured to engage a central recess of the fastener head;
a second driving portion including a pair of flanges extending radially outward from opposing corners of the first driving portion, each flange having a pair of opposing walls and an end wall extending therebetween, the second driving portion configured to engage an elongated slot of the fastener head;
wherein the second driving portion extends radially outward from opposing corners of the first driving portion.

15. The screwdriver of claim 14, wherein the first driving portion is configured to engage a central recess of a combination slotted and Phillips-type fastener.

16. The screwdriver of claim 14, wherein the first driving portion is configured to engage a central recess of a combination slotted and Robertson-type fastener.

17. The screwdriver of claim 14, wherein the first driving portion is configured to engage a central recess of a combination slotted, Phillips and Robertson-type fastener.
